(19) United States
(12) Patent Application Publication
(10) Pub. No.: US 2008/0039041 A1
(43) Pub. Date: Feb. 14, 2008

(54) METHOD AND APPARATUS FOR REDUCING INTER-MODULATION

(75) Inventors: Gregory J. Buchwald, Crystal Lake, IL (US); Lawrence M. Ecklund, Wheaton, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/463,795

(22) Filed: Aug. 10, 2006

(51) Int. Cl. H04B 7/00; H04B 1/06

(52) U.S. Cl. 455/234.1

(57) ABSTRACT

A method and apparatus for reducing inter-modulation within a wireless communications device (100) is provided herein. During operation a wireless communications device will perform frequency analysis on a received signal (125) to determine if any undesirable IM products exist. If undesirable IM products exist, the incoming signal is attenuated by adjusting an automatic-gain control (AGC) threshold for AGC circuitry (101, 107). By adjusting the AGC threshold, the incoming signal will be attenuated at lower gain values, reducing the amount of IM present within the wireless communications device.

### FIELD OF THE INVENTION

The present invention relates generally to reducing inter-modulation (IM) and in particular, to a method and apparatus for reducing IM within a wireless communications device.

### BACKGROUND OF THE INVENTION

In a cognitive portable radio communications device, it is generally accepted that spectrum will be available over many bands from 30 MHz to 1 GHz and above. Additionally, many users may simultaneously be transmitting within these bands. Because of this, and the fact that wide band-width RF front end and early IF stages may be utilized, unwanted inter-modulation (IM) products may be produced within a wireless device operating within these bands. Therefore, a need exists for a method and apparatus for reducing unwanted IM products within a wireless communications device that can utilize available spectrum over many frequency bands.

### BRIEF DESCRIPTION OF THE DRAWINGS

FIG. 1 is a block diagram of a wireless communications device.

FIG. 2 is a block diagram of frequency analysis circuitry in accordance with a first embodiment of the present invention.

FIG. 3 is a block diagram of frequency analysis circuitry in accordance with a second embodiment of the present invention.

FIG. 4 is a flow chart showing operation of the wireless communications device of FIG. 1.

FIG. 5 is a block diagram of a wireless communications device.

### DETAILED DESCRIPTION OF THE DRAWINGS

In order to address the above-mentioned need, a method and apparatus for reducing inter-modulation within a wireless communications device is provided herein. During operation a wireless communications device will perform frequency analysis on a received signals to determine if any undesirable IM products exist. If undesirable IM products exist, the incoming signals are attenuated. Because the incoming signals will be attenuated, the amount of IM present within the wireless communications device will be reduced.

The present invention encompasses a method for performing AGC. The method comprises the steps of receiving a plurality of incoming signals that may cause undesirable IM products, calculating if there exist undesirable IM products caused by the signals, and attenuating the incoming signals if undesirable IM products exist.

The present invention additionally encompasses a method comprising the steps of receiving incoming signals, performing AGC on the incoming signals via AGC circuitry, determining if unwanted IM products exist within the incoming signals, and adjusting an AGC threshold for the AGC circuitry based on the determination that unwanted IM products exist.

The present invention encompasses an apparatus comprising an antenna receiving a plurality of incoming signals that may cause undesirable IM products, logic circuitry calculating if there exist undesirable IM products caused by the signals, and attenuation circuitry attenuating the incoming signals if undesirable IM products exist.

The present invention additionally encompasses a method comprising the steps of receiving a plurality of incoming signals that may cause undesirable IM products, calculating if there exist undesirable IM products caused by the signals, and reporting the calculated IM frequencies or good frequencies to other radios.

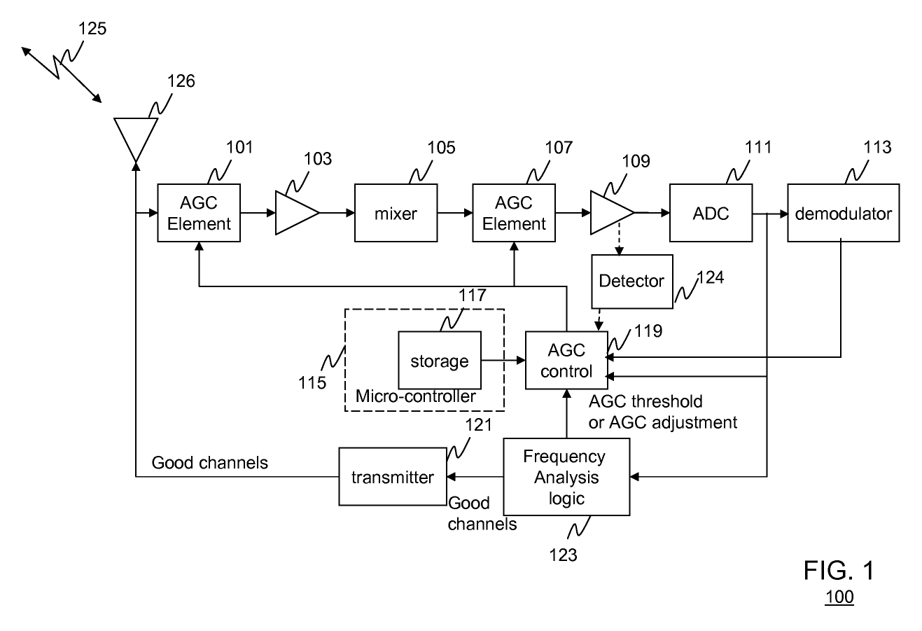

Turning now to the drawings, wherein like numerals designate like components, FIG. 1 is a block diagram of wireless communications device 100. As shown, wireless communications device 100 comprises AGC circuitry 101, linear amplifier 103, mixer 105, AGC circuitry 107, intermediate frequency (IF) amplifier 109, analog-to-digital (ADC) converter 111, and demodulator 113. AGC circuitries 101 and 107 are controlled via AGC controller 119.

During operation incoming wireless communications signals 125 are received by antenna 126 and passed to AGC circuitry 101. As is commonly known in the art, AGC circuitry 101 will attenuate all incoming signals that have a signal strength (power) above an AGC threshold. The AGC threshold comprises a power level of a received signal, at which point the receiver begins to attenuate the received signal. Thus, if received signals 125 have a signal strength above the AGC threshold, the signals will be attenuated by AGC circuitry 101, otherwise, no attenuation takes place.

AGC control circuitry 119 constantly updates the AGC thresholds existing within AGC circuitry 101 and 107. In addition to updating the AGC thresholds, control circuitry 119 will store the current AGC thresholds within storage 117 of microcontroller 115. The storage of AGC thresholds allows for multiple modulation methods and bandwidths, as well as self-learning and operating improvement through memory and decision processes. Additionally, the stored AGC threshold can be utilized upon receiver power-up.

Linear amplifier 103 amplifies the incoming signals and passes them to mixer 105, where the signals are mixed with a frequency source to form an intermediate frequency (IF) signal. The IF signal is again passed to AGC circuitry 107 where the signal will be attenuated by AGC circuitry 107 if the signal strength is above a second threshold. (It should be noted that AGC circuitries 101 and 107 may be utilizing the same or differing thresholds for attenuating incoming signals). The signal output from AGC circuitry 107 is passed to IF amplifier 109 where it is amplified, and then to analog-to-digital converter 111 where the signal is converted to a digital signal. Demodulator 113 then demodulates the digital signal to produce a demodulated signal.

As discussed above, because many users may simultaneously be transmitting within the same frequency band as wireless device 100, unwanted/undesirable inter-modulation (IM) products may be produced by wireless device 100. In order to address this issue, AGC circuitries 101 and 107 will attenuate incoming signals if undesired IM products exist on the portion of the frequency band utilized by device 100, the incoming signal will be attenuated, reducing the unwanted IM products. Thus, simply because IM products exist within the signals, does not necessarily make the IM products undesired. The IM products will only be categorized as undesired if they are above a threshold, and if they fall within a particular frequency band (i.e., one which device 100 will utilize for communications).

In order to attenuate the incoming signal, device 100 must first determine if unwanted IM products exist. In order to accomplish this task, frequency analysis logic circuitry 123 is provided. During operation frequency analysis logic circuitry 123 will determine if there exists any unwanted IM products and depending upon the existence of such unwanted IM products, circuitry 123 will provide an adjustment to the AGC threshold to AGC control circuitry 119. (In an alternate embodiment, the actual AGC threshold may be provided to control 119). The adjusted AGC threshold will be stored in storage 117.

While determining if and where unwanted IM products exist, frequency analysis logic 123 will additionally determine channels where no communications are currently taking place. The channels where no communications take place along with the channels that have undesirable IM will be sent to transmitter 121 and transmitted to infrastructure equipment so that wireless device 100 may be instructed to operate on a good channel (i.e., no IM and no communications). More particularly, in a cognitive radio system the detection of the IM products must be accomplished in the radio in which the IM occurs, however, this information may be useful to other radios of similar design operating within the same geographic location and under similar circumstances. Therefore, this information may be shared with other cognitive radios within the local network and it may also be shared with the control station, if one is designated, to streamline the process of channel selection.

During operation, frequency analysis logic 123 may utilize one of several techniques to determine if unwanted IM products exist. These techniques will be described below:

### FFT Approach

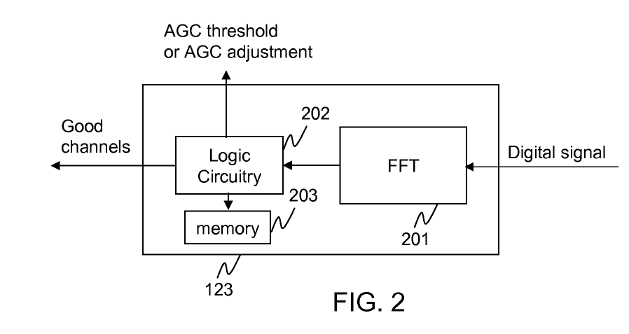

FIG. 2 is a block diagram of frequency analysis circuitry 123 when utilizing a Fast Fourier Transform (FFT) approach to detect IM. During the FFT approach, the analog RF/IF signal is converted to a digital bit stream by ADC 111. An FFT is performed on the digital bit stream by FFT 201 and a first transformed signal is produced. The output of the FFT block (i.e., the first transformed signal) is analyzed by logic circuitry 202 to determine energy within each of the bins, or frequencies. Thus, energy for the various frequencies of the transformed signal is determined. For example, a 2048 point FFT, operating on a 50 MHz wide signal bandwidth, would produce 2048 data points, each separated by 24 k Hz and within the total 50 MHz bandwidth of the sampled signal. In effect, a data point exists each 24 kHz across the total 50 MHz bandwidth of the sampled signal. The 24 kHz samples are then analyzed for energy and a determination is made if energy is detected within each block that exceeds a given threshold. Those blocks that are, in fact, indicating energy are recorded in memory 203.

Next, logic 202 instructs AGC control 119 to attenuate the incoming signal at the input of the receiver such that the energy input to amplifier 103 is reduced by a known amount. This causes the incoming signal to frequency analysis logic 123 to be attenuated. In most cases, a simple 10 or 20 dB attenuation will be temporarily implemented. A second FFT analysis is computed by FFT 201 on the attenuated incoming signal to produce a second transformed signal, and the energy detected (e.g., the energy for various frequencies of the second transformed signal) is re-evaluated on the second transformed signal by logic circuitry 202.

To establish a reference table in receiver memory, logic circuitry 202 compares the energies of the first and the second transformed signals. If the energy for each bin drops by an amount close to or equal to the level of attenuation, it can safely be assumed that no internal IM has been generated on the particular frequency represented by the FFT bin under measurement. If the energy level drops by a factor of 2 or more, on a decibel reference scale basis, it can be deducted that IM was present and that it was internally generated. Any frequencies which indicate internal generation of IM through this measurement means are maintained internally as an additional map of unusable frequencies. They are also, optionally, reported to the radio controlling station as bad channels as well. If logic circuitry 202 calculates the presence of IM, AGC control 119 is instructed to adjust the AGC and reduce the AGC threshold by a pre-determined step size so that the calculated IM can be reduced to an acceptable level or eliminated.

### Swept Spectrum Analysis

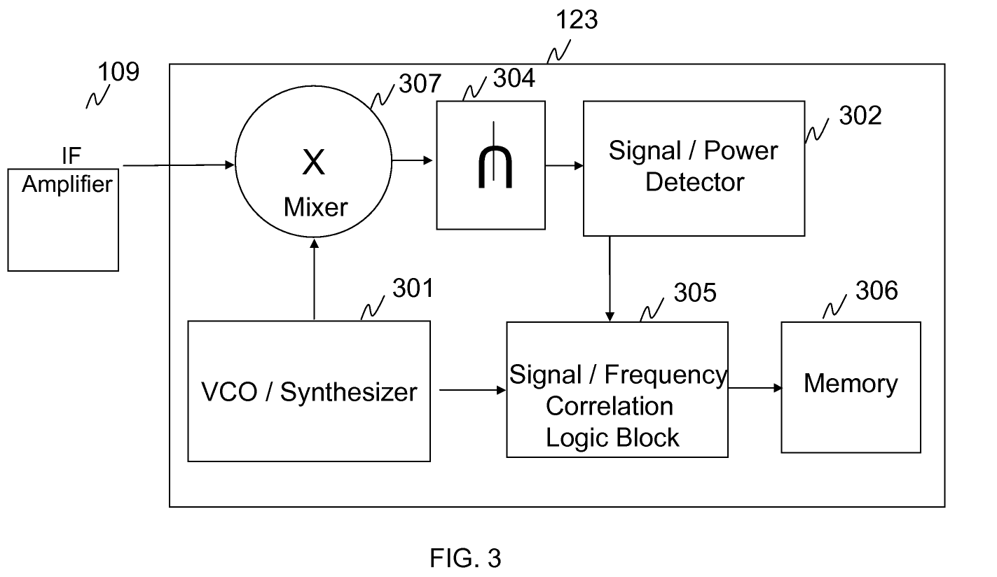

FIG. 3 is a block diagram of frequency analysis circuitry 123 when utilizing a swept frequency approach to detect IM. During the swept frequency analysis, an additional local oscillator 301, mixer 307, and detector 302 are employed by frequency analysis logic 123, along with narrow filter 304. Logic circuitry 305 utilizes these elements to determine the energy detected at a given frequency within a given bandwidth for an incoming signal. The local oscillator is swept and the energy level at the output of the detector are analyzed by logic circuitry 305 and recorded into memory 306. As in the FFT method, the incoming signal is attenuated, and the frequency analysis is repeated on the attenuated incoming signal. Thus, an energy detected at a given frequency within a given bandwidth on the attenuated signal is determined.

The change in detected energy level at those frequencies that were recorded as energy peaks are compared and a determination of external signal vs. internal IM generation is again logged. In other words, a change in energy level at various frequencies is determined between the attenuated incoming signal and the un-attenuated incoming signal. IM is considered internally generated if irregular changes in energy take place for a given frequency. The additional calculated IM frequencies are maintained within the radio as in the previous approach and reported to the controller.

### Power Detection Approach

In a third approach, a short list of frequencies that may be used is compared to a list forwarded by a controlling station. If energy is detected on one or more of the candidate channels assigned by the frequency analysis logic 123, analysis of the energy is performed using the two part analysis in the above swept spectrum examples; however, in this case, local oscillator 301 is not swept; rather, discrete local oscillator frequencies are input to the mixer and analysis is performed at only the discrete frequencies chosen. In the case of this method, a separate local oscillator and detector are not needed; rather, the system mixer and local oscillator are utilized prior to digitizing of the signal. Once again, the IM information deduced is maintained by the radio as well as forwarded to the main system controller.

It should be noted that the above three approaches for determining if unwanted IM exists, all have the step of measuring a power level for the incoming signal after signal attenuation. This step may not be necessary if frequency verses power verses generated IM information is preset. For example, frequency analysis logic 123 may have predetermined power levels, at which a particular frequency will be assumed to have IM prior to attenuation. Thus, prior to attenuation, if a particular frequency has a power level above a threshold, it is assumed that IM is present for that frequency. As noted, the power level at which IM is assumed may be dependent upon frequency. It is also worth noting that the IM that is generated within the receiver is at a different frequency than the first and second signals measured by the above-described methods. The frequency at which IM products are generated follows well-known mathematical processes and can, therefore, be predicted and calculated.

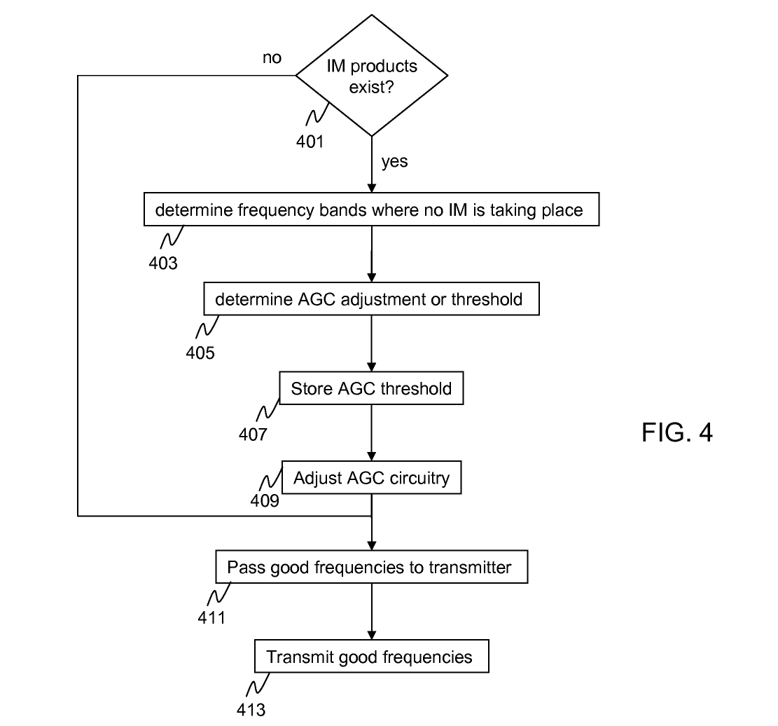

FIG. 4 is a flow chart showing operation of wireless device 100. The logic flow begins at step 401 where frequency analysis logic 123 receives incoming signals that may cause potential undesirable IM products and determines if any unwanted IM products exist within the signal. As discussed above, unwanted IM products preferably comprise IM products existing within the frequency band of operation. Additionally, as discussed, this determination may be accomplished via any one, or a combination of the three techniques described above and comprises measuring power levels of signals at individual carrier frequencies within the plurality of incoming signals and determining if a desired carrier frequency contains IM products at an undesired power level.

If, at step 401, logic 123 determines that no undesirable IM exists, the logic flow continues to step 411 otherwise the logic flow continues to step 403. At step 403 logic 123 determines frequency bands where no IM is taking place. The logic flow continues to step 405 where an AGC threshold or adjustment is determined by logic 123. As discussed above, when undesirable IM is detected the incoming signals are attenuated. In the preferred embodiment of the present invention the attenuation takes place via AGC circuitry, however, in alternate embodiments of the present invention any attenuation circuitry may be utilized. Thus, an adjustment to the AGC threshold is determined and the AGC threshold is adjusted (lowered) to reduce the undesirable IM. The AGC threshold is stored (step 407) in storage 117 and the AGC thresholds for at least one of the AGC circuitries 101 and 107 are adjusted by control circuitry 119 (step 409). A list of good channels (i.e., channels where no IM is taking place) or alternatively a list of bad channels (i.e., channels where the calculated IM exist) is passed from logic 123 to transmitter 121 (step 411) and transmitted to infrastructure equipment (step 413) or simply reported to other radios As discussed above, channels where no communications are taking place may also be transmitted to infrastructure equipment at step 413.

The above technique for reducing undesirable IM products essentially attenuates an incoming signal when undesirable IM products are present. The attenuation is accomplished via adjusting an AGC threshold. As discussed, in alternate embodiments of the present invention other forms of attenuation may take place. For example, a simple signal attenuator may be utilized to attenuate the incoming signals when undesirable IM products exist. This is illustrated in FIG. 5.

As shown in FIG. 5, the AGC circuitry 101 of FIG. 1 has been replace by simple signal attenuation circuitry 501. During operation a plurality of incoming signals are received by antenna 126 that may cause undesirable IM products. Frequency analysis logic 523 will calculate if undesirable IM products exist within the signals and instruct attenuator 501 to attenuate the incoming signals if undesirable IM products are within the signals.

Unlike the embodiments discussed above, apparatus 500 does not attenuate the signals by adjusting an automatic gain control threshold for first AGC circuitry. Instead, apparatus 500 uses simple signal attenuation circuitry 501 to attenuate the signal when undesirable IM products exist. As with the embodiments discussed above, the step of calculating if there exists undesirable IM products within the signal, comprises the steps of measuring power levels of signals at individual carrier frequencies within the plurality of incoming signals and determining if a desired carrier frequency contains IM products at an undesired power level.

While the invention has been particularly shown and described with reference to a particular embodiment, it will be understood by those skilled in the art that various changes in form and details may be made therein without departing from the spirit and scope of the invention. For example, although the above text describes adjustment is made to two AGC circuitries when IM is detected, one of ordinary skill in the art will recognize that adjustment can be made to any number of AGC circuitries when IM is detected. It is intended that such changes come within the scope of the following claims.

1. A method for performing AGC, the method comprising the steps of:
receiving a plurality of incoming signals that may cause undesirable IM products;
calculating if there exist undesirable IM products caused by the signals; and
attenuating the incoming signals if undesirable IM products exist.

2. The method of claim 1 wherein the step of attenuating the incoming signals comprises the step of adjusting an automatic gain control threshold for first AGC circuitry if there exist undesirable IM products.

3. The method of claim 2 wherein the step of adjusting the AGC threshold comprises the steps of:
determining an adjustment to the AGC threshold; and
adjusting an Automatic Gain Control (AGC) threshold by the adjustment.

4. The method of claim 2 further comprising the step of:
adjusting an AGC threshold for a second AGC circuitry if there exist undesirable IM products on the particular channel.

5. The method of claim 2 wherein the AGC threshold comprises a power level of a received signal, at which point the receiver begins to attenuate the received signal.

6. The method of claim 1, wherein the step of calculating if there exist undesirable IM products caused by the signals, comprises the steps of:
measuring power levels of signals at individual carrier frequencies within the plurality of incoming signals; and
determining if a desired carrier frequency contains IM products at an undesired power level.

7. The method of claim 1 wherein the step of calculating if there exist undesirable IM products caused by the signals comprises the steps of:
performing an FFT on a digital bit stream to produce a first transformed signal;
determining an energy for various frequencies of the transformed signal;
attenuating the incoming signals;
performing a second FFT on a digital bit stream to produce a second transformed signal;
determining an energy for various frequencies of the second transformed signal; and
determining if IM exist at particular frequencies by comparing energies of the first and the second transformed signal.

8. The method of claim 1 wherein the step of calculating if there exist undesirable IM products comprises the steps of:
determining an energy detected at a given frequency within a given bandwidth on the incoming signals;
attenuating the incoming signals;
determining an energy detected at the given frequency within the given bandwidth on the attenuated incoming signals;
determining a change in energy level at various frequencies between the attenuated incoming signals and the un-attenuated incoming signals; and
determining if undesirable IM products exist based on the change in energy level at various frequencies.

9. A method comprising the steps of:
receiving incoming signals;
performing AGC on the incoming signals via AGC circuitry;
determining if unwanted IM products exist; and
adjusting an AGC threshold for the AGC circuitry based on the determination that unwanted IM products exist.

10. The method of claim 9 wherein the AGC threshold comprises a power level of a received signal, at which point the receiver begins to attenuate the received signal.

11. The method of claim 9 further comprising the step of:
storing the adjusted AGC threshold; and
utilizing the adjusted ACG threshold upon power-up.

12. The method of claim 9 wherein the step of determining if unwanted IM products exist comprises the steps of:
performing an FFT on a digital bit stream to produce a transformed signal;
determining an energy for various frequencies of the transformed signal;
attenuating the incoming signal;
performing a second FFT on a digital bit stream to produce a second transformed signal;
determining an energy for various frequencies of the second transformed signal; and
determining if IM exist by comparing energies of the first and the second transformed signal.

13. The method of claim 9 wherein the step of determining if unwanted IM products exist comprises the steps of:
determining an energy detected at a given frequency within a given bandwidth on the incoming signals;
attenuating the incoming signals;
determining an energy detected at the given frequency within the given bandwidth on the attenuated incoming signals;
determining a change in energy level at various frequencies between the attenuated incoming signals and the un-attenuated incoming signals; and
determining if unwanted IM products exist based on the change in energy level at various frequencies.

14. An apparatus comprising:
an antenna receiving a plurality of incoming signals that may cause undesirable IM products;
